(19) United States
(12) Patent Application Publication
(10) Pub. No.: US 2017/0308348 A1
(43) Pub. Date: Oct. 26, 2017

(54) SYSTEM AND METHOD FOR VERY LARGE-SCALE COMMUNICATION AND ASYNCHRONOUS DOCUMENTATION IN VIRTUAL REALITY AND AUGMENTED REALITY ENVIRONMENTS

(71) Applicant: John SanGiovanni, Seattle, WA (US)

(72) Inventor: John SanGiovanni, Seattle, WA (US)

(21) Appl. No.: 15/216,981

(22) Filed: Jul. 22, 2016

Related U.S. Application Data
(63) Continuation of application No. 15/134,326, filed on Apr. 20, 2016.

(51) Int. Cl. G06F 3/14; G06F 3/01; G06T 19/00; G06F 3/16; H04L 29/08; G06F 3/0482

(52) U.S. Cl. CPC G06F 3/1454; G06F 3/16; G06F 3/013; G06F 3/012; G06T 19/006; G06F 3/0482; H04L 67/10; H04L 67/34

(57) ABSTRACT

The invention disclosed herein provides systems and methods for simplifying virtual reality (VR), augmented reality (AR), or virtual augmented reality (VAR) based communication and collaboration through a streamlined user interface framework that enables both synchronous and asynchronous interactions in immersive environments.

### CROSS-REFERENCES TO RELATED APPLICATIONS

This application is a continuation of U.S. patent application Ser. No. 15/134,326, filed on 20 Apr. 2016.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

The invention disclosed herein provides systems and methods for simplifying virtual reality (VR), augmented reality (AR), or virtual augmented reality (VAR) based communication and collaboration through a streamlined user interface framework that enables both synchronous and asynchronous interactions in immersive environments.

### BRIEF DESCRIPTION OF INVENTION

VR, AR, VAR systems (hereinafter, collectively or individually as VAR) viewed in spherical coordinates or other three dimensional environments or immersive environments require complex and heavyweight files for all stakeholders who wish to collaborate in these environments. There is a need to simplify VAR environments for synchronous and asynchronous interaction and communication.

Generally, as used herein, a publisher may publish a VAR environment in an immersive environment for a participant to view and/or annotate at a later time or asynchronously. A user may view the annotated VAR environment in an immersive environment. A publisher, participant, third party, or combination thereof may be a user.

According to one embodiment, a participant's movement throughout a VAR immersive environment is recorded or tracked. According to one embodiment, movement means a participant's focus point (FP) from a starting point (SP) through more than one FP in a VAR immersive environment According to one embodiment, a participant's FP is determined by the participant's head position and/or eye gaze. According to one embodiment, the participant annotates his movement through a VAR immersive.

According to one embodiment, there exists more than one participant. According to one embodiment, there exists more than one user. According to one embodiment, the participant's movement in the VAR immersive environment is traced for a user with a visible reticle.

According to one embodiment, the reticles may have different colors, shapes, icons, etc. According to one embodiment, more than one user may synchronously or asynchronously view the annotated immersive environment.

According to one embodiment, published and/or annotated VAR immersive environment maybe viewed on a mobile computing device such as a smart-phone or tablet. According to one embodiment, the participant may view the immersive environment using any attachable binocular optical system such as Google Cardboard or other similar device. According to one embodiment, a publisher, participant or user may interact with an annotated or unannotated VAR immersive environment via a touch sensitive screen or other touch sensitive device.

### DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a flow chart which shows an exemplary embodiment of the systems and methods described herein;

FIG. 1A is a flow chart which shows an exemplary embodiment of the systems and methods described herein;

FIG. 1B is a flow chart which shows an exemplary embodiment of the systems and methods described herein;

FIG. 2 is an exemplary VAR immersive environment shown in two-dimensional space;

FIG. 3 is an exemplary embodiment of a touch screen;

FIG. 4 is an exemplary embodiment of a graphical representation.

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. Given by way of overview, illustrative embodiments include systems and methods for simplifying VAR based communication and collaboration through a streamlined user interface framework that enables both synchronous and asynchronous interactions in immersive environments.

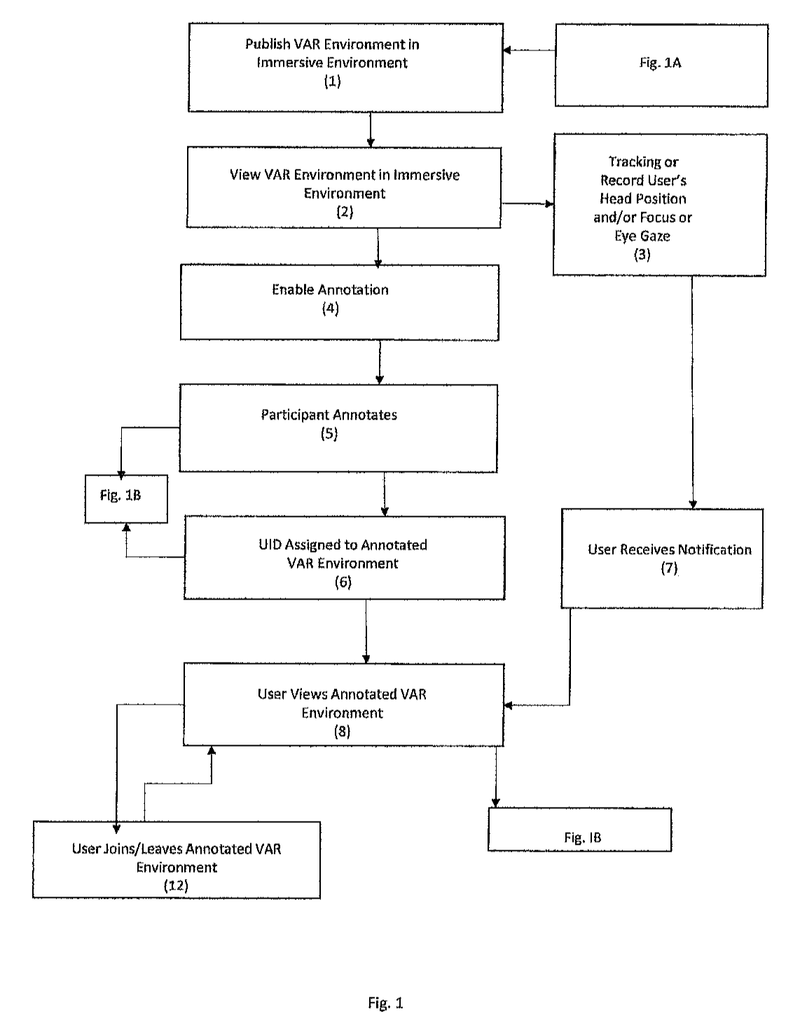

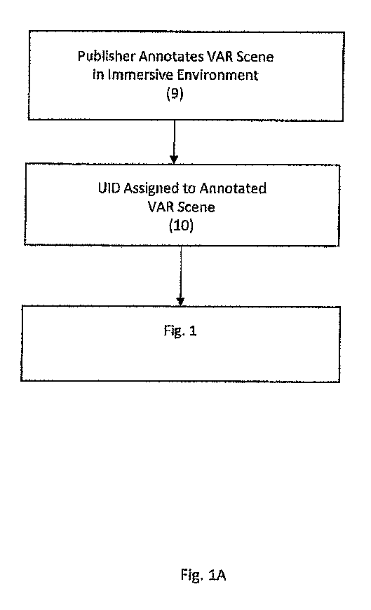

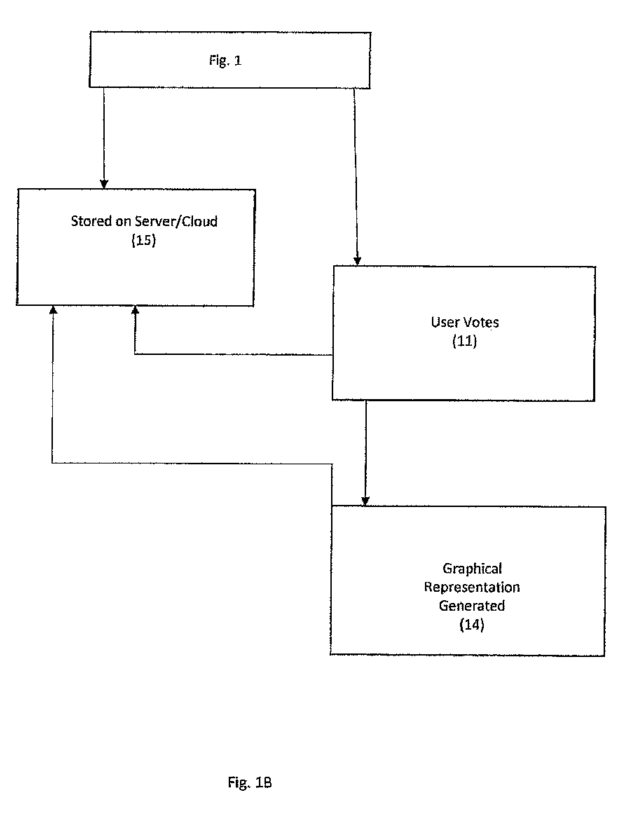

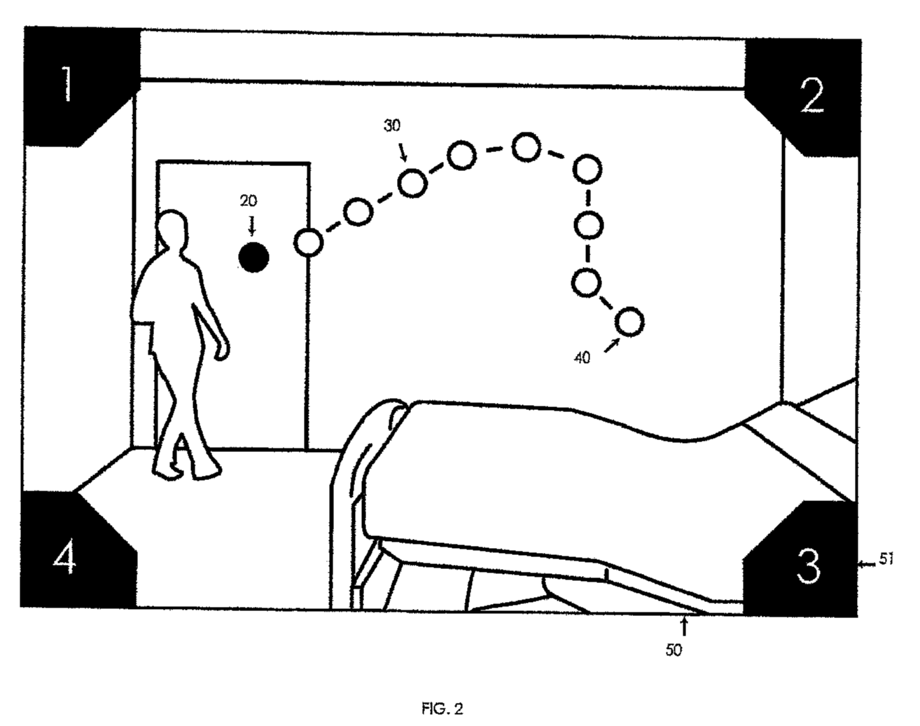

Referring to FIGS. 1, 1A, 1B and 2, as described above, a publisher may publish a VAR environment in an immersive environment (1) for a participant or user to view and/or annotate (2) at a later time or asynchronously. A user may view the annotated VAR environment in an immersive environment. (8) A publisher, participant, third party, or combination thereof may be a user.

According to one embodiment, a participant's movement throughout a VAR immersive environment is recorded or tracked. Movement throughout a VAR immersive environment means tracking or recording a participant's focus point (FP) from a starting point (SP) through more than one FP in the VAR immersive environment. According to one embodiment, a participant's FP (30) is determined by head position and/or eye gaze. According to one embodiment, a participant annotates his movement throughout a VAR immersive environment. (5)

According to one embodiment, annotation is voice annotation from a SP (20) through more than one FP (30). According to another embodiment, annotation is movement throughout the VAR environment. In another embodiment, annotation is movement throughout the VAR environment coordinated with voice annotation though the same space. (5) According to one embodiment, the participant's annotation is marked with a unique identifier or UID. (6)

According to one embodiment, a user may view an annotated immersive environment. (8) According to one embodiment, a user receives notice that a participant has annotated an immersive environment. (7) The user may then review the annotated immersive environment. (8)

According to one embodiment, the participant is more than one participant. (2) According to one embodiment, more than one participant may view the VAR immersive environment asynchronously on a VAR platform. (2) According to one embodiment, more than one participant may annotate the VAR immersive environment asynchronously. (5) According to one embodiment, more than one participant may view the VAR immersive environment synchronously (2) but may annotate the environment asynchronously. (5) According to one embodiment, each annotated immersive environment is marked with a UID. (6)

According to one embodiment, the user is more than one user. According to one embodiment, more than one user may synchronously view one annotated immersive environment on a VAR platform. (8) According to one embodiment, at least one user may join or leave a synchronous viewing group. (12) According to one embodiment, at least one user may view at least one UID annotated VAR immersive environment on a VAR platform. (8).

Referring to FIGS. 1 and 1A, according to one embodiment, a publisher may annotate a VAR immersive environment prior to publishing (9). According to one embodiment, the published annotated VAR immersive environment is assigned a UID. (10)

Referring to FIG. 2, according to one embodiment, a participant's movement throughout a VAR immersive environment is shown by a reticle (40). According to one embodiment, each participant's and/or publisher's movements throughout a VAR immersive environment may be shown by a distinctive visible reticle (40). According to one embodiment, each distinctive visible reticle (40) may be shown as a different color, shape, size, icon etc.

According to one embodiment, a VAR immersive environment is viewed on a touch-sensitive device (50). A touch-sensitive device (50) is a device that responds to the touch of, a finger for example, by transmitting the coordinates of the touched point to a computer. The touch-sensitive area may be the screen itself, in which case it is called a touch-screen. Alternatively, it may be integral with the keyboard or a separate unit that can be placed on a desk; movement of the finger across a touchpad causes the cursor to move around the screen.

According to one embodiment, the user may view the VAR immersive environment on a mobile computing device (50), such as a smart phone or tablet, which has a touch screen. (2) According to one embodiment, the user may view the VAR immersive environment using any attachable binocular optical system such as Google Card Board, or other similar device.

According to one embodiment, the user may select an action that affects a VAR immersive environment by touching a portion of the screen that is outside (51) the VAR immersive environment. According to one embodiment, the actions are located on the corners of the touch screen (51). This allows the user to ambidextrously select an action. According to one embodiment, the user may select an action by manipulating a touch pad. An action may include: choosing one from 1, 2, 3, 4; choosing to publish, view, annotate; choosing to teleport; choosing to view a point of interest; choosing to view one of several annotations; choosing to enter or leave a VAR Platform when synchronously viewing an annotated immersive VAR environment; amongst others.

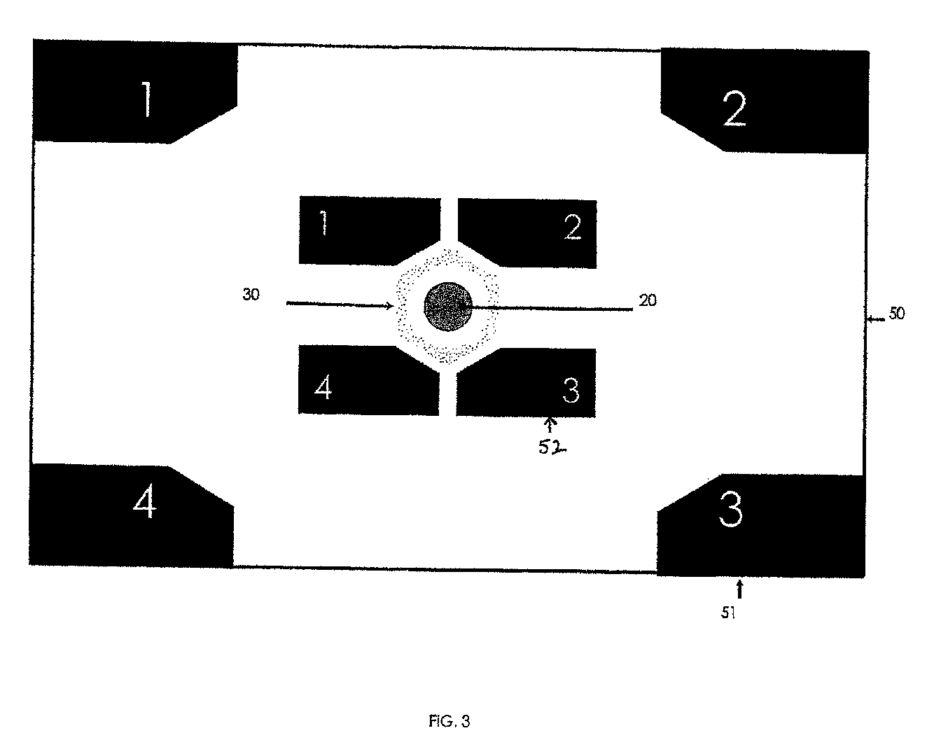

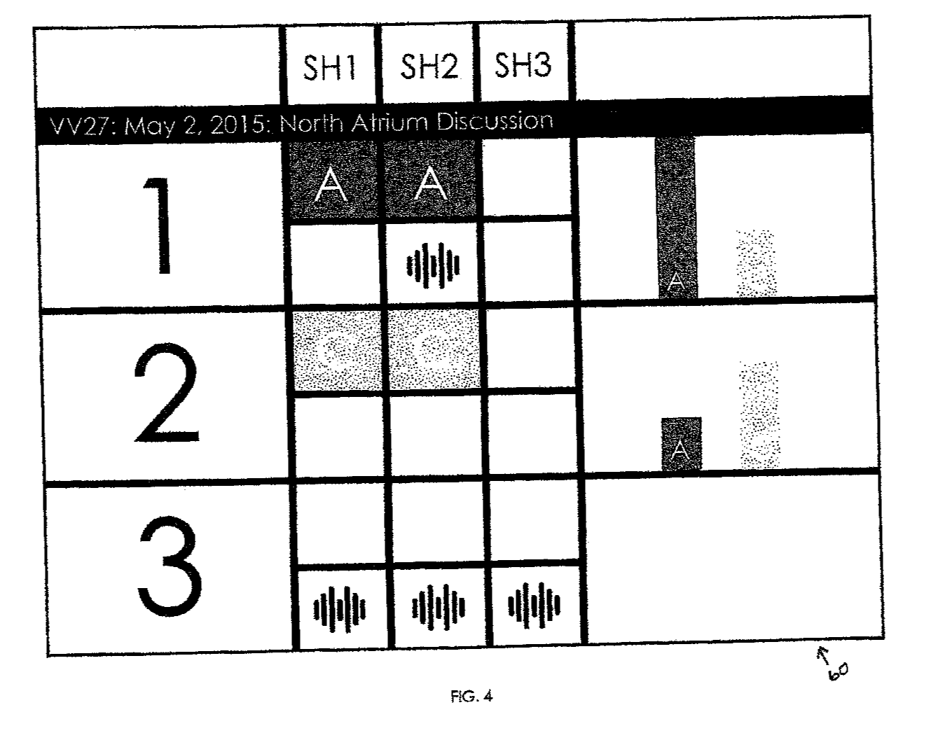

Referring to FIGS. 1, 1A, 1B and 3, according to another embodiment, the user may select an action that affects the VAR immersive environment by selecting a hot point (52) within the VAR immersive environment. According to another embodiment, the selected hot point (52) determines the actions a user may select outside the (51) the VAR immersive environment. According to one embodiment, selecting an action means voting for at least one attribute from a plurality attributes. (11) According to one embodiment, selected attributes are represented graphically (60). FIG. 4 shows an exemplary graphical presentation. As will be appreciated by one having skill in the art, a graphical representation may be embodied in numerous designs.

Referring to FIGS. 1-4, according to one embodiment, a content publisher (such as a professional designer or engineer, or a consumer of user-generated content) publishes a VAR immersive environment to a stakeholder (participant). (1) The content publisher may request the stakeholder to provide input about a particular room, for example. The stakeholder views the published VAR immersive environment. (2) The participant may choose a hot spot (52) or a touch-screen (51), or a combination thereof to annotate the VAR immersive environment (4). Multiple stakeholders may view and annotate the VAR immersive environment asynchronously. (8)

According to one embodiment, the content professional may ask at least one user to vote (11) from the recommendations of more than one stakeholder where, a vote is given after viewing each annotated VAR immersive environment (5). According to one embodiment, each vote may be graphically presented. (14) According to one embodiment, the user may choose a hot spot (53) or a touch screen (51), or a combination thereof to vote.

According to one embodiment, the more than one stakeholder may synchronously view at least one annotated VAR environment on a VAR platform. (8) According to one embodiment, the more than one stakeholder may choose one out of a plurality of annotated VAR environments to view. (8) According to one embodiment, the more than one stakeholder may choose more than one annotated VAR environments to view simultaneously. (8) According to one embodiment, at least one of the more than one stakeholder may join or leave synchronous viewing group. (12) According to one embodiment, at least one published VAR immersive environment, annotated immersive environment, vote, graphical representation or a combination thereof may be stored or processed on a server or cloud. (15) One skilled in the art will appreciate that more than one server or cloud may be utilized.

As will be appreciated by one skilled in the art, aspects of the present invention may be embodied as a system, method or computer product. Accordingly, aspects of the present invention may take the form of an entirely hardware embodiment, entirely software embodiment (including firmware, resident software, micro-code, etc.) or an embodiment combining software and hardware aspects. Further aspects of this invention may take the form of a computer program embodied in one or more readable medium having computer readable program code/instructions thereon. Program code embodied on computer-readable medium may be transmitted using any appropriate medium, including but not limited to wireless, wireline, optical fiber cable, RF, etc., or any suitable combination of the foregoing. The computer code may be executed entirely on a user's computer, partly on the user's computer, as a standalone software package, a cloud service, partly on the user's computer and partly on a remote computer or entirely on a remote computer, remote or cloud based server.

I claim as my invention:

1. A method for providing asynchronous annotations in an augmented reality or virtual augmented reality environment over an immersive environment comprising:
(a) publishing an augmented reality or virtual augmented reality environment over an immersive environment for at least one participant to view;
(b) enabling the
(c) at least one participant to annotate participant's movement throughout the augmented reality or virtual augmented reality environment.

2. The method according to claim 1 where movement throughout the augmented reality or virtual augmented reality environment is the participant's track from a starting point and through more than one focus point.

3. The method according to claim 2 where annotation is:
tracking or recording a participant's head position and/or focus or eye gaze from a starting point through more than one focus points in the immersive environment;
recording participant voice annotation from a starting point through more than one focus points; or
a combination thereof.

4. The method according to claim 3 further comprising enabling a user to view the annotated augmented reality or virtual augmented reality environment in the immersive environment where the user is a publisher, a participant, as third party, or a combination thereof.

5. The method according to claim 4 where the path of annotation in the immersive environment is shown as a reticle.

6. The method according to claim 3 where a user is more than one user.

7. The method according to claim 6 further comprising enabling more than one user to synchronously view annotation in the immersive environment.

8. The method according to claim 7 further comprising enabling at least one user to join or leave synchronous viewing.

9. The method according to claim 3 further comprising assigning a unique identifier to annotation.

10. The method according to claim 1 where the participant is more than one participant.

11. The method according to claim 10 enabling the more than one participant to view the virtual reality or virtual augmented reality environment in an immersive environment synchronously or asynchronously.

12. The method according to claim 10 further comprising enabling at least one participant to join or leave synchronous viewing.

13. The method according to claim 1 further comprising enabling annotation prior to publishing.

14. The method according to claim 1 further comprises enabling the user to view the augmented reality or virtual augmented reality environment over the immersive environment on a portable computing device.

15. The method according to claim 14 where the portable computing device is a smart-phone or a tablet.

16. The method according to claim 15 where the user selects an action that will cause change in the augmented reality or virtual augmented reality environment.

17. The method according to claim 16 where select an action means voting for at least one attribute from a plurality attributes, moving to a different location in the augmented reality or virtual augmented reality environment, or a combination thereof.

18. The method of according to claim 18 where selected attributes are represented graphically.

19. The method according to claim 19 where at least one published virtual reality or virtual augmented reality immersive environment, annotated immersive environment, vote, graphical representation or a combination thereof is stored or processed on a server or cloud.
